(19) United States
(12) Patent Application Publication
(10) Pub. No.: US 2011/0134558 A1
(43) Pub. Date: Jun. 9, 2011

(54) DISK DEVICE, HEAD DISTANCE CALCULATION METHOD, AND OFFSET CONTROL METHOD

(75) Inventors: Daigo NAKAMURA, Ome-shi (JP); Koji HOSOKAWA, Ome-shi (JP)

(73) Assignee: KABUSHIKI KAISHA TOSHIBA, Tokyo (JP)

(21) Appl. No.: 12/963,457

(22) Filed: Dec. 8, 2010

(30) Foreign Application Priority Data
Dec. 8, 2009 (JP) 2009-278796

(51) Int. Cl. G11B 27/36

(52) U.S. Cl. 360/31; G9B/27.052

(57) ABSTRACT

According to one embodiment, a disk device comprises a magnetic head module, a measurement module, and an arithmetic operation module. The magnetic head module includes a read head and a write head wherein an offset is present therebetween. The measurement module writes a measurement signal into a disk medium, reads the measurement signal while moving the read head in the radial direction, and obtains a measurement value of the offset based on a level of the read measurement signal. The arithmetic operation module obtains an estimate value of a distance between the write head and the read head based on a design value of the distance, a design value of the offset calculated by the design value of the distance, and the measurement value of the offset.

### CROSS-REFERENCE TO RELATED APPLICATIONS

This application is based upon and claims the benefit of priority from Japanese Patent Application No. 2009-278796, filed Dec. 8, 2009; the entire contents of which are incorporated herein by reference.

### FIELD

Embodiments described herein relate generally to an art of controlling an offset between a read head and a write head in a disk device.

### BACKGROUND

In general, a disk device (also referred to as a disk drive) typified by a hard disk drive is provided with a magnetic head for recording data in or reproducing data from a magnetic disk medium (hereinafter simply referred to as a magnetic disk) which is a storage medium. As the magnetic head, a composite head is used in which a read head and a write head are separate and mounted on the same slider. The read head generally comprises a magnetoresistive (MR) element or a giant magnetoresistive (GMR) element, and performs a read operation (data reading operation). The write head generally comprises an inductive thin film head element, and performs write operation (data writing operation).

This kind of head is generally installed in a rotary actuator. The actuator is configured to be driven to rotate radially on a disk medium by the driving force of a voice coil motor (VCM) and thereby position the head at a target position (target track or target cylinder) on the disk medium.

Meanwhile, when the head is positioned on the disk medium by the rotary actuator, a gap distance (Grw) is present in a circumferential direction because the read head and the write head are separate. Moreover, since the read head and the write head are differently positioned radially on the disk medium due to the angle of rotation of the actuator, a so-called offset is generated.

Specifically, in a read operation for reproducing data, a position correction corresponding to an offset has to be made when the read head is to be positioned at a data position (track position) where the data has been recorded on the disk medium by the write head (see Jpn. Pat. Appln. KOKAI Publication No. 2005-216378 and Jpn. Pat. Appln. KOKAI Publication No. 2001-134905).

In Jpn. Pat. Appln. KOKAI Publication No. 2005-216378, an offset value OF is found as follows from an angle (skew angle) θ between a line connecting the rotation center (pivot) of the actuator to the central point of the head and a tangent to a track arc and from a gap distance G between the read head and the write head.

OF=G×sin θ

In a manufacturing process of the disk drive, parameters (the gap distance G and the skew angle θ for each track) necessary for the calculation of an offset value are stored in a memory in advance (see paragraph 0033).

In reading, in response to a read command from a host system, a target position TP which is a target track where data to be read is recorded is set, and the actuator is driven and controlled to perform a seek operation for moving the read head to a position located in the vicinity of the target position TP. Then a positioning operation (tracking operation) is performed to place the read head on a track position which is the target position TP. During this positioning operation, a position correction based on the offset is made (see paragraph 0040).

In Jpn. Pat. Appln. KOKAI Publication No. 2001-134905, a radial offset X between a write element and a read element is determined by the relation between the distance between the write element and the read element and the skew angle (see paragraph 0027).

In each of the patent documents, the skew angle and the gap distance between the read head and the write head which are parameters for calculating the offset value are provided as design values in the manufacturing process, and stored in the memory. That is, the gap distance is not actually found.

Although the gap distance is designed to be several μm, the distance varies to a certain degree in manufacture because the read head and the write head are small components. As the recording density TPI (the number of tracks per inch: tracks per inch) of the hard disk drive increases, the gap distance is becoming an important parameter that influences an error rate. Although the variation of the gap distance does presently not influence on the error rate or cause a drift-off, the variation of the gap distance will not be negligible if there is a further rise in TPI (presently, 323 kTPI, track pitch: Tp of 79 nm or more).

For example, when the gap distance is 0.0045 mm, the offset is 89.7 nm on the outer circumference (cycle: 10). If the gap distance varies 5 percent, the offset has an error of 4 nm, which appears as a shift of 6 percent for 323 kTPI (Tp of 79 nm).

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary block diagram showing the configuration of a disk device according to an embodiment.

FIG. 2 is an exemplary schematic diagram illustrating an RW offset and RW gap between a read head and a write head.

FIG. 3 is an exemplary flowchart showing an offset measurement operation.

### DETAILED DESCRIPTION

Various embodiments will be described hereinafter with reference to the accompanying drawings.

In general, according to one embodiment, a disk device comprises a magnetic head module, a measurement module, and an arithmetic operation module. The magnetic head module comprises a read head and a write head wherein an offset is present between the read head and the write head. The measurement module is configured to write a measurement signal into a disk medium, to read the measurement signal while moving the read head in a radial direction of the disk medium, and to obtain a measurement value of the offset based on a level of the read measurement signal. The arithmetic operation module is configured to obtain an estimate value of a distance between the write head and the read head based on a design value of the distance between the write head and the read head, a design value of the offset calculated by the design value of the distance, and the measurement value of the offset.

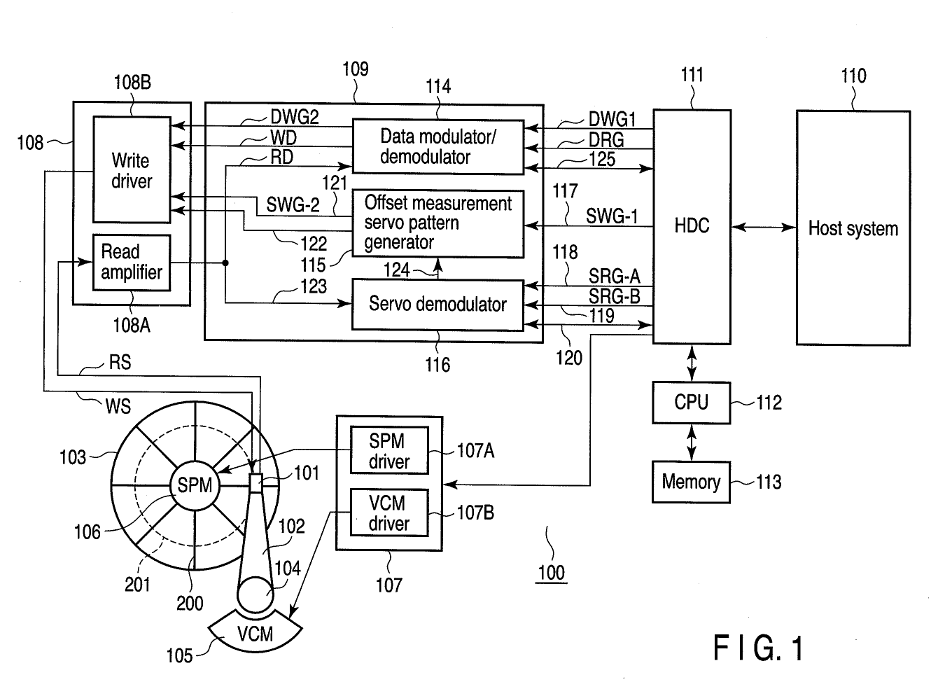

FIG. 1 is a block diagram illustrating the configuration of a disk drive 100 according to an embodiment.

The disk drive 100 according to the embodiment comprises a device mechanism (drive mechanism) and a later-described control/signal processing system. The device mechanism includes a magnetic head 101, a disk medium (hereinafter referred to as a magnetic disk) 103 which is a magnetic storage medium, a spindle motor (SPM) 106 which rotates the magnetic disk 103, and an actuator on which the magnetic head 101 is mounted to move the magnetic head 101 radially on the magnetic disk 103.

The magnetic head 101 includes a read head for reading (reproducing) data and servo information from the magnetic disk 103, and a write head for writing (recording) data and servo patterns for offset measurement (position information for offset measurement) in the magnetic disk 103. The magnetic head 101 has the read head and write head separately mounted on one slider which is a head main unit. Thus, a given offset (position shift) is produced between the track loci of the read head and the write head. An offset value is dependent on radial positions on the disk. Here, the write head is located closer to the tip of the actuator than the read head. On inner circumferential tracks, the write head is located closer to the inner circumferential side than the read head. On outer circumferential tracks, the write head is located closer to the outer circumferential side than the read head.

The actuator comprises a suspension & arm 102 equipped with the magnetic head 101, a pivot 104 serving as a rotation shaft, and a voice coil motor (VCM) 105 which includes a coil, a magnet and a yoke and which generates drive force. The actuator is controlled to move radially on the magnetic disk 103 under head positioning control (servo control) by a later-described microprocessor (CPU) 112. As a result, the magnetic head 101 is positioned at a target position (target track) on the magnetic disk 103.

On the magnetic disk 103, a plurality of radial servo regions 200 having predetermined spaces in the circumferential direction are provided, and a great number of concentric tracks (cylinders) 201 are further provided. In addition, the tracks 201 mean both a data track in which user data is recorded by the write head and a servo track composed of a plurality of servo regions 200.

The servo information is recorded in the servo regions 200. The servo information includes an address code (cylinder code) for identifying each track, and a servo burst signal for detecting the position of the magnetic head 101 in the track. The CPU 112 uses the servo information read by the read head to perform the head positioning control (servo control).

The control/signal processing system comprises a motor driver 107, a head amplifier unit 108, a read/write channel 109, a hard disk controller (HDC) 111, the CPU 112 and a memory 113. The motor driver 107 has an SPM driver 107A for supplying a drive current to the SPM 106, and a VCM driver 107B for supplying a drive current to the VCM 105.

The head amplifier unit 108 includes a read amplifier 108A for amplifying a read signal RS read by the read head of the magnetic head 101 and then outputting the amplified signal to the read/write channel 109. The head amplifier unit 108 also includes a write driver 108B for converting write data WD output from the read/write channel 109 into a write signal (write current) WS and then supplying the write signal WS to the write head of the magnetic head 101. The write driver 108B converts the write data WD into the write signal WS in accordance with the timing of a write gate DWG2 output from a data modulator/demodulator 114.

The read/write channel 109 is a signal processing unit for processing read/write data signals. The read/write channel 109 has the data modulator/demodulator 114, an offset measurement servo pattern generator 115 and a servo demodulator 116.

The data modulator/demodulator 114 modulates (encodes) record data 125 which is transferred from the HDC 111, to the write data WD by the timing of a write gate DWG1. The data modulator/demodulator 114 also demodulates (decodes) a read data signal RD output from the read amplifier 108A, to the record data 125 in accordance with the timing of a read gate DRG from the HDC 111, and outputs the record data 125 to the HDC 111.

The offset measurement servo pattern generator 115 generates servo record data 122 including a servo write gate signal 121 (SWG-2) and an offset measurement servo pattern (offset measurement position information) in accordance with the timing of a servo write gate signal 117 (SWG-1) output from the HDC 111. At the same time, a synchronization signal 124 is input to the generator 115 from the servo demodulator 116.

The servo demodulator 116 demodulates (decodes) a servo reproduction signal 123 output from the read amplifier 108A into servo data 120 including an address code and servo burst signals (A to D), and outputs the servo data 120 to the HDC 111. At the same time, the servo demodulator 116 demodulates the servo burst signals (burst patterns A, B) in accordance with the timing of a servo read gate 118 (SRG-A) and servo read gate 119 (SRG-B) that are output from the HDC 111.

The HDC 111 configures an interface between the disk drive 100 and a host system (personal computer or digital equipment) 110, and controls the read/write transfers of the user data to/from the host system 110. The HDC 111 also controls the read/write operations of the read/write channel 109.

The CPU 112 is a main controller of the disk drive 100, and is a main component of a servo system for performing the head positioning control (servo control). The CPU 112 performs a seek operation and tracking operation (position control) in the head positioning control, and also performs the estimation of a read/write gap and offset control (DOC) according to the embodiment.

The memory 113 includes a flash memory, a ROM and a RAM. Various kinds of data necessary for the control operation of the CPU 112 are stored in the memory 113.

How to obtain the distance: gap distance (also referred to as a read-write gap) between a read gap of the read head and a write gap of the write head in the disk device having the configuration described above is described.

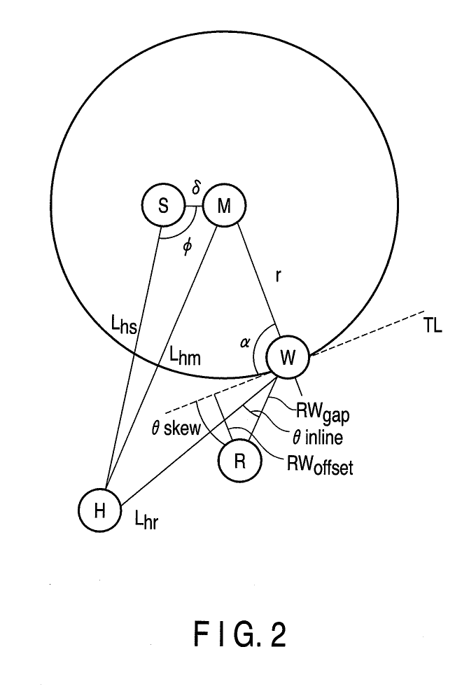

FIG. 2 is a schematic diagram showing an offset and the gap distance. A point H indicates the pivot of a head stack assembly (HSA) which is a mechanical part for holding the magnetic head 101 in FIG. 1 to rotate and move the magnetic head 101 to a predetermined position of the magnetic disk. A point S indicates the rotation center of the SPM 106. A point M indicates the center of a servo cylinder. A point R indicates the gap position of the read head. A point W indicates the gap position of the write head. The gap position of the write head is located closer to the inner circumferential side than the gap position of the read head. The center of the disk (servo pattern) is not coincident with the center of the spindle motor (SPM), and is eccentric (disk shift). The cause of the disk shift includes, for example, variations during manufacture (a recording error of a servo track writer for recording the servo information, and an attachment error of the spindle motor), and externally given shock or vibration.

The following equations are obtained from FIG. 2.

$$\begin{matrix}{L}_{hm} = \sqrt{{L}_{hs}^{2} + {δ}^{2} - 2 {L}_{hs} δ cos φ} & ( 1 ) \\ α = {cos}^{- 1} ( \frac{{L}_{hw}^{2} + {r}^{2} - {L}_{hm}^{2}}{2 {L}_{hw} r} ) & ( 2 ) \\ {θ}_{skew} ( ϕ ) = α + {θ}_{inline} - ( π / 2 ) & ( 3 ) \\ {RW}_{offset} = {RW}_{gap} \times sin ( {θ}_{skew} ) & ( 4 )\end{matrix}$$

It is understood from Equation (4) that the gap RW_{gap} is proportional to the offset RW_{offset}. In addition, the offset in Equation (4) is an absolute value. As described above, on the inner circumferential tracks, the write head is located closer to the inner circumferential side than the read head. On the outer circumferential tracks, the write head is located closer to the outer circumferential side than the read head. The skew angle is known. Thus, an offset RW_{offset0} for a gap design value RW_{gap0} is found from Equation (4). If an actual measurement value of an offset in a certain track is RW_{offset}, an estimate value of the gap RW_{gap} can be found as follow:

RW_{gap}=RW_{gap0}×(RW_{offset}/RW_{offset0}) (5)

Parameters Lhm, Lhs, φ are known. Thus, the following three parameters are required for the estimation of gap RW_{gap}.

δ: disk shift amount, r: radial position, RW_{offset}

The disk shift amount δ can be calculated by measuring a cylinder address by pressing each head onto the inner circumference and calculated from the TPI. Differences resulting from stacks are eliminated by calculating the disk shift amount for each head as described above. The radial position r can be calculated from the TPI.

The offset value RW_{offset} can be found by a position at which the level of a reproduction signal is maximized when a measurement pattern is written into a particular region of the disk and is then read while the head is being moved in the diametrical direction of the disk.

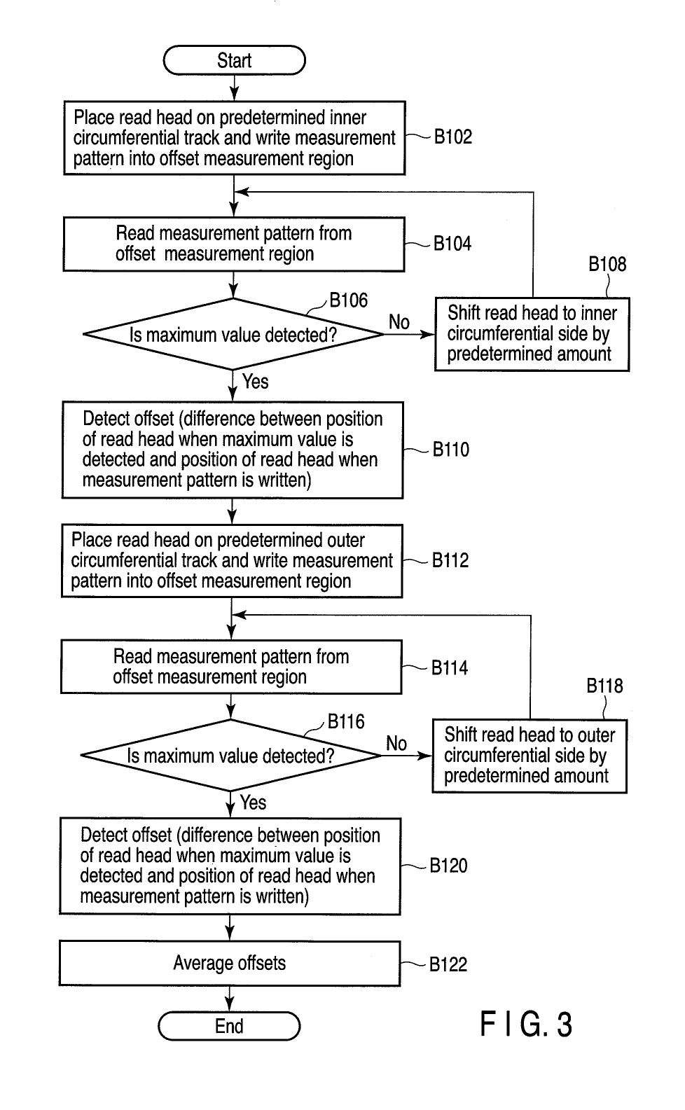

Specifically, a signal (measurement pattern) for offset value measurement is written into an offset measurement region of the disk. For example, as shown in FIG. 3, in block B102, the measurement pattern is written into the offset measurement region via the write head while the read head is being placed on a predetermined data recording track located in the vicinity of the innermost circumference (the read head is being placed on the same pattern radial position as the predetermined data recording track). In this case, due to the offset, the measurement pattern is recorded at the inner circumferential radial position which is located off the track center to correspond to the off-track amount (offset value) of the write head.

Furthermore, the measurement pattern is read from the offset measurement region, and a position is identified which is coincident with the radial center of the region where the measurement pattern has been written, that is, the center of the write head in the recording width direction during the writing of the measurement pattern. First, in block B104, the measurement pattern is read from the offset measurement region. In this case, if the read head is off the write region of the measurement pattern toward the inner circumferential side or the outer circumferential side, the output level (amplitude value) of the reproduction signal regarding the read measurement pattern is decreased. On the contrary, if the radial center in the write region of the measurement pattern coincides with the center in the read width direction (radial direction) of the read head, the output level of the reproduction signal regarding the read measurement pattern is maximized. Thus, the central position of the read head when the output level of the reproduction signal regarding the measurement pattern is maximized is specified as the radial center of the region where the measurement pattern is written. The distance between the specified center and the center of the read head during the writing of the measurement pattern (i.e., the center of the data recording track) is taken as the offset value of the write head relative to the read head. That is, whether the maximum value of the reproduction signal is detected is determined in block B106. When the maximum value is not detected, the read head is moved a predetermined amount (e.g., 0.05 Tp (track pitch)) to the inner circumferential side in block B108, and the reproduction of the measurement pattern in block B104 is repeated. When the maximum value is detected, the difference between the position of the read head when the maximum value is obtained and the position of the read head when the measurement pattern is recorded is designated as an offset in block B110.

Measurement of one reference track at a given radial position is theoretically sufficient for RW_{offset} for the calculation for Equation (5). However, the offset value RW_{offset} is dependent on sin (θ_{skew}) as shown in Equation (4), and the value of the skew angle θ_{skew} is greater at positions closer to the inner circumference or outer circumference. Moreover, measurement error factors such as sensitivity characteristics of the head are also included. Therefore, the off-track amount (offset value RW_{offset}) is also greater at positions closer to the inner circumference or outer circumference.

Thus, at least two tracks located in the vicinity of the innermost circumference and outermost circumference are used as reference tracks to measure the offset value RW_{offset}. To this end, in block B112 to block B120, an offset is measured for an outer circumferential track, and the average value is found (block B122). The operation is different from that for the inner circumferential track in that the read head is moved to the outer circumferential side in block B118.

The average value of the offsets measured for the inner and outer circumferential tracks is used as the actual measurement value RW_{offset} in Equation (5) to obtain the estimate value of the gap RW_{gap}. The offset values RW_{offset} may be measured at a plurality of other radial positions, and the average of these values may be calculated.

As the gap distance RW_{gap} can be thus estimated for every product, the offset RW_{offset} can be accurately found in accordance with Equation (4). Therefore, when the read head is positioned, during the read operation, at the data position (track position) where data has been recorded on the disk medium by the write head, a position correction that conforms to the correct offset can be made. One example of the position correction is dynamic offset control (DOC) described in U.S. Pat. No. 7,057,844 (corresponding to Jpn. Pat. Appln. KOKAI Publication No. 2005-216378) and U.S. patent application Ser. No. 12/421,539 (corresponding to Jpn. Pat. Appln. KOKAI Publication No. 2009-176403). The DOC controls the offset amount of a primary component resulting from a phase difference seen from an RW gap, and thereby controls the tracks of the read head/write head. It is said that the influence of the dynamic offset obviously appears when the dynamic offset amount is about 13 percent (8 nm in current TPI) or more of the track pitch Tp. The DOC uses Equation (4) to control the offset value, and the offset control amount is proportional to the RW gap. For example, if the RW gap has an error of 10 percent, the dynamic offset amount is also influenced 10 percent. Thus, an accurate RW gap is needed for accurate dynamic off-track control.

According to the embodiment, the estimate value of the RW gap can be found for every product from Equation (5), so that if RW_{offset} is found as shown in Equation (6) in which Equation (5) is substituted for Equation (4), more precise RW_{offset} is calculated than heretofore. RW_{offset} changes depending on a radial position, and is currently calculated approximately to the function of the radial position. Therefore, RW_{offset} found from Equation (6) is more accurate than RW_{offset} based on the current approximate calculation.

RW_{offset}RW_{gap0}×(RW_{offset}/RW_{offset0})×sin(θ_{skew}) (6)

The distance between the read head and the write head is estimated from an RW offset value, and the estimated value is added to a DOC correction value, thereby enabling control optimized for each head and improving the error rate.

A correct offset value can be calculated, such that off-track retries are expected to be reduced, and performance is enhanced.

According to the embodiment, the offset values of the read head and write head can be directly measured for every product. Thus, an offset value that changes within one rotation of the disk medium can be calculated by an accurate and short-time measurement. Consequently, it is possible to provide a useful disk drive which ensures that a DOC correction can be made without deteriorating data access performance and which also ensures that the read head can be positioned on a desired track.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a magnetic head module comprising a read head, a write head and an offset between the read head and the write head;
a measurement module configured to write a signal into a disk medium, to read the signal while moving the read head in a radial direction of the disk medium, and to measure the offset based on a level of the signal read; and
a processor configured to estimate a distance between the write head and the read head based on a design distance between the write head and the read head, a design offset calculated by the design distance, and the measured offset.

2. The disk device of claim 1, wherein the processor is configured to estimate the distance based on a ratio of the design offset to the measured offset and based on the design distance.

3. The disk device of claim 1, wherein the measurement module is configured to measure the offsets for two tracks on an inner circumferential side and an outer circumferential side of the disk medium, and to calculate an average of the two measured offsets.

4. The disk device of claim 3, wherein the measurement module is configured to position the read head on a predetermined track in order to write the signal into the disk medium via the write head, to read the signal while moving the read head in a radial direction of the disk medium, and to measure the offset based on a position of the read head where a maximum value of the level of the read signal is obtained.

5. A head distance calculation method of a disk device, the disk device comprising a magnetic head module comprising a read head, a write head and an offset between the read head and the write head, the offset control method comprising:
writing a signal into a disk medium;
reading the signal while moving the read head in a radial direction of the disk medium;
measuring the offset based on a level of the signal read; and
estimating a distance between the write head and the read head based on a design distance between the write head and the read head, a design offset calculated by the design distance, and the measured offset.

6. The method of claim 5, wherein estimating comprises:
estimating the distance based on a ratio of the design offset to the measured offset and based on the design distance.

7. The method of claim 5, wherein measuring the offset comprises:
measuring the offsets for two tracks on an inner circumferential side and an outer circumferential side of the disk medium; and
calculating an average value of the two measured offsets.

8. The method of claim 7, further comprising:
positioning the read head on a predetermined track to write the signal into the disk medium via the write head;
reading the signal while moving the read head in a radial direction of the disk medium; and
measuring the offset based on a position of the read head where a maximum value of the level of the read signal is obtained.

9. An offset control method of a disk device, the disk device comprising a magnetic head module comprising a read head, a write head and an offset between the read head and the write head, and a rotary actuator configured to hold the magnetic head module, the offset control method comprising:
writing a signal into a disk medium;
reading the signal while moving the read head in a radial direction of the disk medium;
measuring the offset based on a level of the signal read;
estimating a distance between the write head and the read head based on a design distance between the write head and the read head, a design offset calculated by the design distance, and the measured offset;
calculating the offset based on the estimated distance and a skew angle between a line connecting a rotation center of the rotary actuator and a central point of the magnetic head module and a tangential line to an arc-shaped track of the disk medium; and
positioning the read head during reading in accordance with the calculated offset.

10. The method of claim 9, wherein estimating comprises:
estimating the distance based on a ratio of the design offset to the measured offset and based on the design distance.

11. The method of claim 9, wherein obtaining the measurement value of the offset comprises:
measuring the offsets for two tracks on an inner circumferential side and an outer circumferential side of the disk medium; and
calculating an average value of the two measured offsets.

12. The method of claim 11, further comprising:
positioning the read head on a predetermined track to write the signal into the disk medium via the write head;
reading the signal while moving the read head in a radial direction of the disk medium; and
measuring the offset based on a position of the read head where a maximum value of the level of the read signal is obtained.
